(19) United States
(12) Patent Application Publication
(10) Pub. No.: US 2009/0119600 A1
(43) Pub. Date: May 7, 2009

(54) SYSTEM AND METHOD FOR EVALUATING RESPONSE PATTERNS

(75) Inventors: Patrick Joseph O'Sullivan, Ballsbridge (IE); Robert Cameron Weir, Westford, MA (US); Edith Helen Stern, Yorktown Heights, NY (US); Barry E. Willner, Briarcliff Manor, NY (US); Carol Sue Zimmet, Boxborough, MA (US)

Correspondence Address: HOLLAND & KNIGHT, 10 ST. JAMES AVENUE, BOSTON, MA, 02116-3889, US

(73) Assignee: INTERNATIONAL BUSINESS MACHINES CORPORATION, Armonk, NY (US)

(21) Appl. No.: 11/934,169

(22) Filed: Nov. 2, 2007

(51) Int. Cl. G06F 3/00

(52) U.S. Cl. 715/745

(57) ABSTRACT

A method and computer program product for evaluating response patterns including monitoring a plurality of interactions of a user. A response pattern of the user is defined based upon, at least in part, the plurality of interactions of the user. A response profile of the user is provided based upon, at least in part, the response pattern.

### TECHNICAL FIELD

This disclosure relates to managing communications and, more particularly, to systems and methods for evaluating response patterns and histories.

### BACKGROUND

Email, instant messaging, text messaging, as well as other communications systems that exist today have converged to leave consumers of the technologies with various ways in which they can be contacted or interacted with. However, the many communication systems also provide various ways in which a person can be interrupted. Interruptions by way of mail, IM, SMS, telephone, calendar invites, e-meetings, voice mail, organizational web conferences, cellular, and so on, are hugely time consuming and are oftentimes a nuisance for those who wish to concentrate on a task, or manage their day in relation to tasks they want to get done.

In an attempt to manage interruptions, a person may choose to ignore various communications attempts, for example from people or on subjects they deem less important than the task at hand. For example, a user may receive an email from an unknown sender. Because the sender is unknown, the user may regard the email as less important than a current project. Unfortunately, once the email has been ignored, it may also be forgotten.

### SUMMARY OF DISCLOSURE

In a first implementation, a method includes monitoring a plurality of interactions of a user. A response pattern of the user is defined based upon, at least in part, the plurality of interactions of the user. A response profile of the user is provided based upon, at least in part, the response pattern of the user.

One or more of the following features may be included. The plurality of interactions may include interactions on one or more communication channel. The plurality of interactions may include one or more of emails, instant messages, text messages, voice communications, and scheduled meetings.

The response pattern of the user may be based upon, at least in part, one or more communications sent to the user. Similarly, the response pattern of the user may be based upon, at least in part, one or more communications originated by the user.

Providing the response profile of the user may include providing the response profile to the user. Additionally, providing the response profile of the user may include providing the response profile to a third party.

The response profile of the user may include a number of communications not responded to. Further, the response profile of the user may include an average time for responding to communications. The response profile of the user may include information about a plurality of communication channels.

According to another implementation, a computer program product resides on a computer readable medium and has a plurality of instructions stored thereon. When executed by a processor, the instructions cause the processor to perform operations including monitoring a plurality of interactions of a user. A response pattern of the user is defined based upon, at least in part, the plurality of interactions of the user. A response profile of the user is provided based upon, at least in part, the response pattern of the user.

One or more of the following features may be included. The plurality of interactions may include interactions on one or more communication channel. The plurality of interactions may include one or more of emails, instant messages, text messages, voice communications, and scheduled meetings.

The response pattern of the user may be based upon, at least in part, one or more communications sent to the user. Similarly, the response pattern of the user may be based upon, at least in part, one or more communications originated by the user.

The instructions for providing the response profile of the user may include instructions for providing the response profile to the user. Similarly, the instructions for providing the response profile of the user may include instructions for providing the response profile to a third party.

The response profile of the user may include a number of communications not responded to. Further, the response profile of the user includes an average time for responding to communications. The response profile of the user may include information about a plurality of communication channels.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an interaction tracking process and an relationship application coupled to a distributed computing network.

FIG. 2 is a flowchart of a process executed by the interaction tracking process of FIG. 1.

FIG. 3 shows a display screen rendered by the interaction tracking process and/or a relationship application of FIG. 1.

FIG. 4 shows a display screen rendered by the interaction tracking process and/or a relationship application of FIG. 1.

FIG. 5 shows a display screen rendered by the interaction tracking process and/or a relationship application of FIG. 1.

FIG. 6 shows a display screen rendered by the interaction tracking process and/or a relationship application of FIG. 1.

FIG. 7 shows a display screen rendered by the interaction tracking process and/or a relationship application of FIG. 1.

FIG. 8 shows a display screen rendered by the interaction tracking process and/or a relationship application of FIG. 1.

FIG. 9 shows a user interface screen rendered by the interaction tracking process of FIG. 1.

### DETAILED DESCRIPTION OF THE PREFERRED EMBODIMENTS

### System Overview:

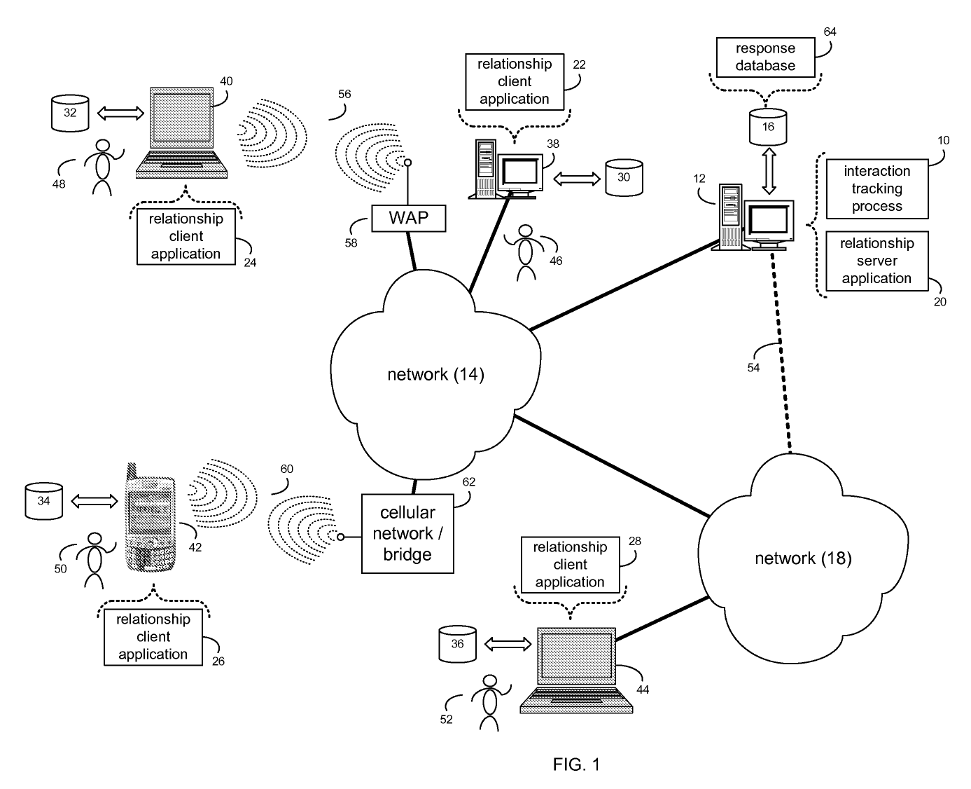

Referring to FIG. 1, there is shown interaction tracking process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, interaction tracking process 10 may reside on and be executed, in whole or in part, by a client electronic device, such as a personal computer, notebook computer, personal digital assistant, or the like.

As will be discussed below in greater detail, interaction tracking process 10 may monitor a plurality of interactions of a user. Interaction tracking process 10 may define a response pattern of the user based upon, at least in part, the plurality of interactions of the user. A response profile of the user may be provided based upon, at least in part, the response pattern of the user. Interaction tracking process 10 may provide the user and/or one or more third parties with information relating to the user's response patterns concerning one or more interactions (e.g., within a single communication channel and/or across multiple communication channels). For example, interaction tracking process 10 may provide information relating to the number of un-responded to communications of the user, and an average time for responding to communications, as well as other information regarding the user's response patterns.

The instruction sets and subroutines of interaction tracking process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more relationship server applications, e.g., relationship server application 20. Examples of relationship server application 20 may include, but are not limited to, email server applications, which may include scheduling/calendaring modules or applications (e.g., Lotus Domino™ Server and Microsoft Exchange™ Server), instant messaging server applications (e.g., IBM Lotus Sametime™, Microsoft Office Live Communications Server™, Jabber XCP™, and AOL Instant Messenger™), voice over IP server applications or PBX telephone systems, and text messaging application (e.g., SMS, or short message service, applications). Relationship server application 20 may interact with relationship client applications 22, 24, 26, 28, examples of which may include, but are not limited to, email client applications that may include scheduling/calendaring modules or applications (e.g., Lotus Notes™ and Microsoft Outlook™), instant messaging client applications (e.g., AOL Instant Messenger™, IBM Lotus Sametime™, Google Talk™), voice over IP client applications, softphone applications, text messaging (SMS, or short message service) client applications. Interaction tracking process 10 may be a stand alone application that interfaces with relationship server application 20 or may be an applet/application that is executed within relationship server application 20.

The instruction sets and subroutines of relationship server application 20, which may be stored on storage device 16 coupled to server computer 12 may be executed by one or more processors (not shown) and one or more memory architectures (not shown) incorporated into server computer 12.

As mentioned above, in addition/as an alternative to being a server-side application residing on server computer 12, the interaction tracking process may be a client-side application (not shown) residing on one or more storage device (e.g., stored on storage device 30, 32, 34, 36) coupled to one or more client electronic device (e.g., client electronic devices 38, 40, 42, 44, respectively). As such, the interaction tracking process may be a stand alone application that interfaces with an application (e.g., relationship client applications 22, 24, 26, 28), or may be an applet/application that is executed within an application (e.g., relationship client applications 22, 24, 26, 28). As such, the interaction tracking process may be a client-side process, a server-side process, or a hybrid client-side/server-side process, which may be executed, in whole or in part, by server computer 12, or one or more of client electronic device 38, 40, 42, 44.

The instruction sets and subroutines of relationship client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices devices 38, 40, 42, 44 may include, but are not limited to, personal computer 38, laptop computer 40, personal digital assistant 42. notebook computer 44, a data-enabled, cellular telephone (not shown), and a dedicated network device (not shown), for example. Using relationship client applications 22, 24, 26, 28, users 46, 48, 50, 52 may, for example, access interaction server application 20 and may, e.g., conduct email communications, schedule/manage calendar events, conduct instant messaging communications, conduct voice communications, browse the internet, and the like.

Users 46, 48, 50, 52 may access relationship server application 20 directly through the device on which the client application (e.g., relationship client applications 22, 24, 26, 28) is executed, namely client electronic devices 38, 40, 42, 44, for example. Users 46, 48, 50, 52 may access relationship server application 20 directly through network 14 or through secondary network 18. Further, server computer 12 (i.e., the computer on which relationship server application 20 is executed) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### The Interaction Tracking Process:

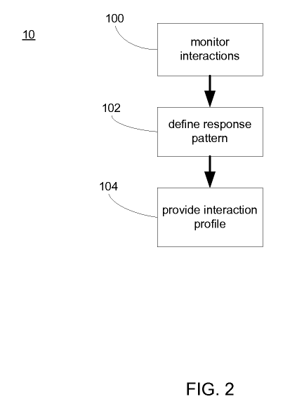

Referring also to FIG. 2, interaction tracking process 10 may monitor 100 a plurality of interactions of a user. Additionally, interaction tracking process may define 102 a response pattern for the user based upon, at least in part, the plurality of interactions of the user. Interaction tracking process may also provide 104 a response profile based upon, at least in part, the response pattern of the user. As such, interaction tracking process 10 may allow various characteristics to be determined regarding the interactions of the user. For example, the user may be able to determine how many communications have been received from a third party, but have not been responded to, the average response time to communications received by the user, as well as various other information relating to interactions of the user.

For example, user 46 may have a plurality of interactions with one or more other users (e.g., users 48, 50, 52) using various relationship applications (e.g., relationship client applications 22, 24, 26, 28 and/or relationship server application 20). The plurality of interactions may include interactions on one or more communication channel, e.g., using relationship client application 22. The interactions may include one or more of emails, instant messages, text messages, voice communications, and scheduled meetings.

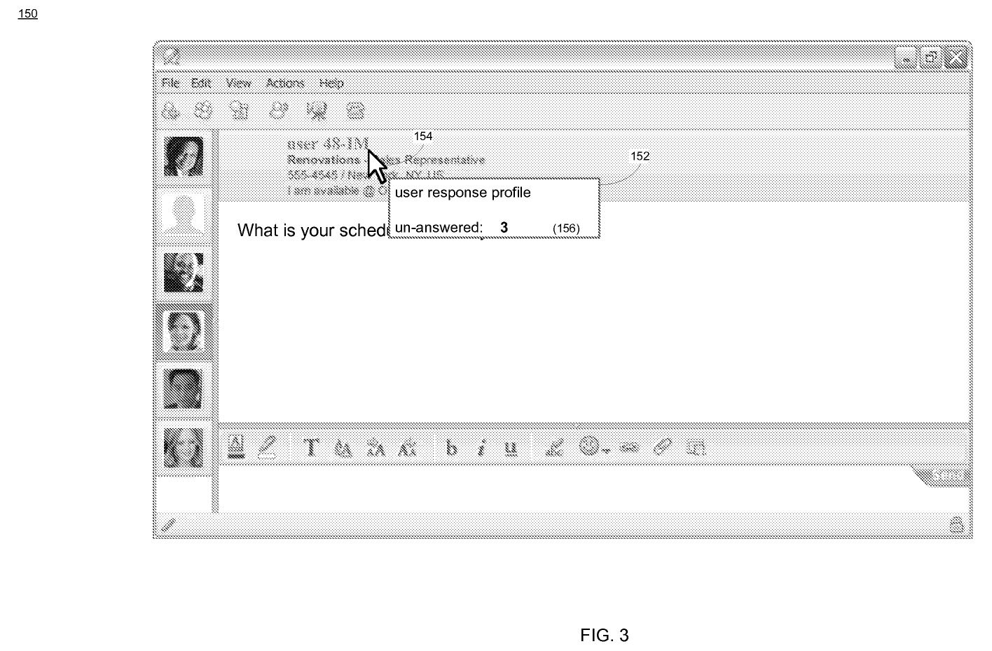

The response pattern of the user may be based upon, at least in part, one or more communications sent to the user. For example, user 46 may receive an instant message from user 48. Referring also to FIG. 3, instant messaging display window 150 may be rendered by instant messaging client application 22 and/or interaction tracking process 10. Instant messaging display window 150 displaying an instant message received from user 48. Instant messaging display window 150 may include user 48's instant messaging identification (i.e., user 48-IM). Interaction tracking process 10 and/or the instant messaging client application (e.g., relationship client application 22) may also provide 104 a response profile for user 46, e.g., as response profile popup 152, which may be displayed when user 46 positions onscreen pointer 154 on instant messaging display window 150 using a pointing device (e.g., a mouse; not shown). Response profile popup 152 may be displayed automatically (e.g., in the form of a hover-over popup) when onscreen pointer 154 is positioned anywhere on instant messaging display window 150, or may be rendered in response to an action by user 46 (e.g., right clicking on one or more portions of instant messaging display window 150).

The response profile may include a number of communications not responded to. Continuing with the above stated example, user 46 may have previously received three instant messages from user 48, to which user 46 did not respond. Interaction tracing process 10 may have monitored 100 the interactions of user 46 (e.g., including the un-responded to instant messages from user 48). Interaction tracking process 10 may define 102 a response pattern for user 46 including the number of un-responded to instant messages from user 48. Response profile popup 152 may include response profile fields, including un-answered field 156. Un-answered field 156 may display the number of communications received by user 48 that user 46 has not responded to (i.e., three un-responded to instant messages). Interaction tracking process 10 may, in the foregoing manner provide 104 user 46 with a response profile based upon, at least in part, user 46's response pattern, and appraise user 46 that he has received three instant messages from user 48 that have not been responded to.

The pattern of un-responded to instant messages from user 48 may be an intentional decision by user 46, or may have been inadvertent. For example, user 46 may have received each of the previous instant messages from user 48 at a time when it was inconvenient to respond. Despite intending to respond at a later time, once the instant messages were ignored, user 46 may have forgotten about them. As such user 46 may have established an inadvertent pattern of not responding to instant messages from user 48. Once being appraised of the number of un-responded to instant messages (e.g., by response profile popup 152), user 46 may make an informed decision of whether to ignore yet another instant message from user 48 or to take the time to respond, thereby breaking the pattern of ignoring instant message attempts by user 48.

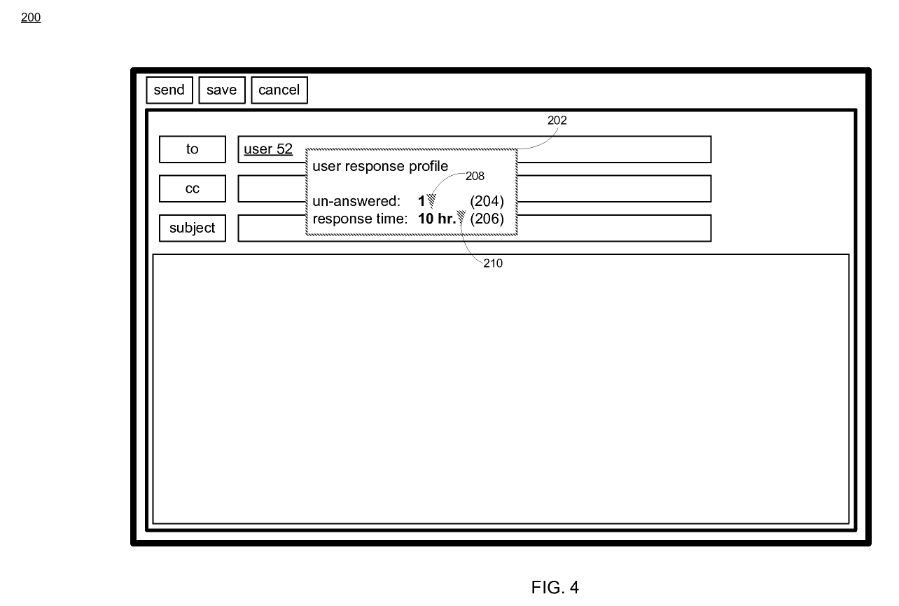

Interaction tracking process 10 may also provide 104 a response profile of a user to a third party. Continuing with the above stated example, and referring also to FIG. 4, user 46 may intend to send an email to user 52, e.g., using email creation window 200 rendered by an email client application (e.g., relationship client application 22). In creating the email, user 46 may enter user 52's email address (e.g., user 52). In response to entering user 52's email address (i.e., user 52), right-clicking on user 52's email address, or the like, interaction tracking process 10 and/or the email client application may render response profile popup 202, providing 104 a user response profile of user 52 to user 46.

The response profile for user 52 provided 104 by interaction tracking process 10 may be based upon, at least in part, a response pattern defined 102 for user 52, which may be based upon, at least in part, one or more communications originated by user 52. Continuing with the above stated example, response profile popup 202 rendered by the email client application and/or interaction tracking process 10 may include un-answered field 204 and response time field 206. Response profile popup 202 may indicate that user 52 has received one un-answered communication, e.g., in un-answered field 204. Response profile popup 202 may also indicate that the average response time of user 52 is ten hours.

Based upon the response profile provided 104 for user 52 (e.g., in response profile popup 202) user 46 may know that user 52 has received one communication that has not been answered, and that user 52's average time for responding to a communication is ten hours. Based upon this information, user 46 may evaluate and/or reconsider his attempt to email user 52. For example, if user 46 intends to contact user 52 regarding an immediately pending matter, user 46 may decide that the ten hour average response time for user 52 is too long, and may, for example, call user 52, or attempt communication by a different means.

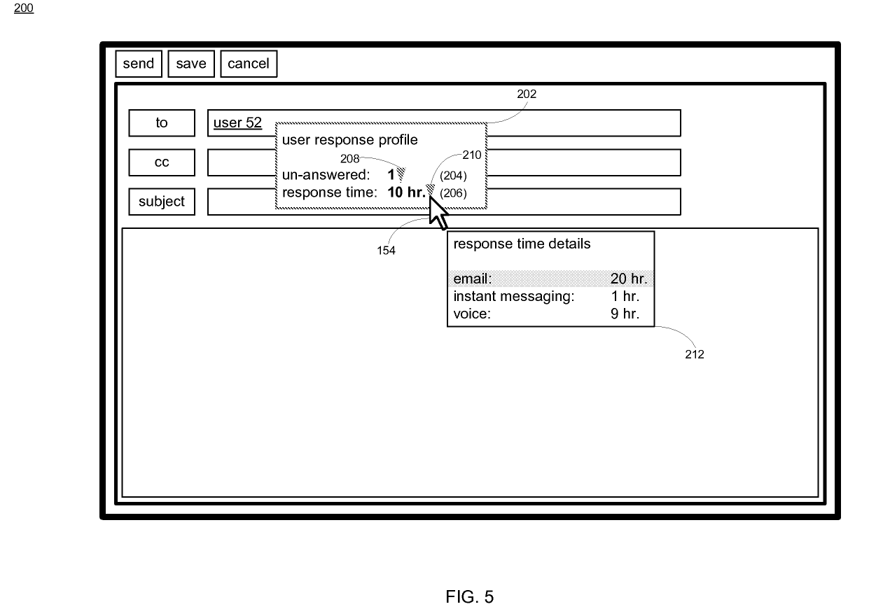

Interaction tracking process 10 may provide 104 a user response profile that includes information regarding a user response pattern defined 102 for a plurality of communication channels. Continuing with the above stated example, and referring also to FIG. 5, interaction tracking process 10 may provide an indication that information regarding user 52's response profile includes information regarding more than one communication channel. For example, un-answered field 204 and response time field 206 may include expansion features (e.g., down arrows 208, 210, respectively). User 46 may select down arrow 210 of response time field 206 using onscreen pointer 154 controlled by the pointing device. Selecting down arrow 210 may result in interaction tracking process 10 and/or the email client application rendering response time details popup 212, which may provide additional information.

Continuing with the above-stated example, response time details popup 212 may include a plurality of communications channels, e.g., including “email”, “instant messaging”, and “voice”, for example. Response time details popup 212 may indicate that user 52 has an average response time of 20 hours for email, one hour for instant messaging, and nine hours for voice calls, giving an average of ten hours for the three communication channels. Based upon, at least in part, this information, user 46 may proceed with sending user 52 an email, or if more immediate response is required, may choose to send and instant message or place a voice call. Various other communication channels may also be considered by interaction tracking process 10, e.g., in details popup 212.

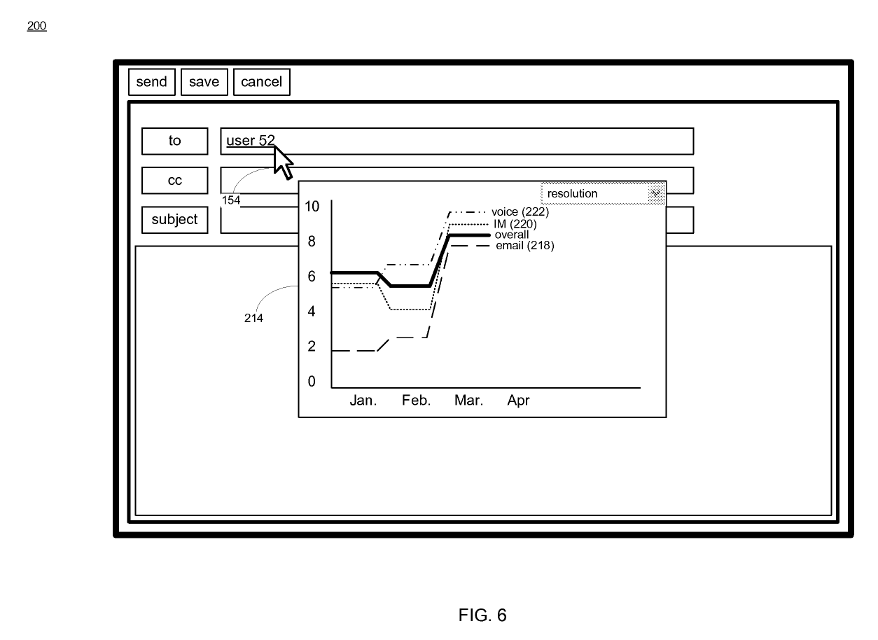

Providing 104 the user response profile may additionally/alternatively include providing a user response profile reflecting the user's response patterns over time. Further, in addition/as an alternative to text based presentation, interaction tracking process 10 may provide 104 the user response profile via graphical presentation. For example, and referring also to FIG. 6, from email creation window 200, user 46 may right-click on user 52′ email address (i.e., user 52). Right-clicking on user 52 may result in interaction tracking process 10 and/or the email client application (e.g., relationship client application) rendering response history graph 214.

Via response history graph 214, interaction tracking process 10 may provide 104 user 52's response profile over time. For example, trend 216 may reflect user 52's overall response pattern across all communication channels (e.g., email, instant messaging, text messages, and the like). As indicated by trend 216, user 52 may have exhibited a relatively poor response history for the months of January and February, but may have exhibited greater responsiveness in the month of March. As such, the provided 104 user response profile may indicate changes in user responsiveness over time (i.e., changes in response patterns). The responsiveness indicated by trend 216 may be based upon, for example, one or more of ratio of received to answered communications, average time for responding to a communication, as well as any various other metric indicative of responsiveness.

In addition to trend 216, reflecting user 52's overall response pattern, response history graph 214 may include, for example, trends 218, 220, 222 respectively indicating user 52's response pattern for various communication channels (e.g., email, instant messaging, and voice communications). For example, while trend 216 may indicate a pattern of relatively poor response during the months of January and February, trends 218, 220, 222 may indicate that the relatively poor overall response history may be based on comparatively very low responsiveness for email, with greater responsiveness for instant messaging and voice communications. User 46 may, for example, use the information relating to user 52's response patterns to choose a desired communication channel for communicating with user 52.

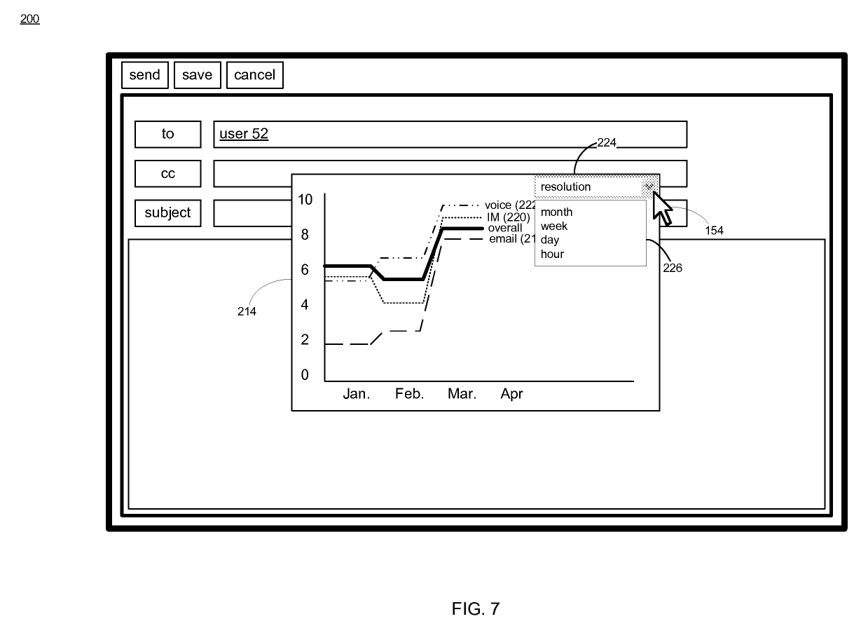

While the granularity of response history graph 214 is shown at the month level, more detailed (e.g., week, day, hour, etc.) information may be displayed. For example, and referring also to FIG. 7, user 46 may select, via onscreen pointer 154, resolution drop down 224. Selecting resolution drop down 224 may result in interaction tracking process 10 and/or relationship client application 22 (e.g., which may be an email client application) rendering resolution menu 226. Resolution menu 226 may include one or more resolution options, namely “month”, “week”, “day”, “hour”. User 46 may select, via onscreen pointer 154 a desired resolution for response history graph 214 resulting in interaction tracking process 10 and/or relationship client application 22 rendering response history graph 214 in the selected resolution.

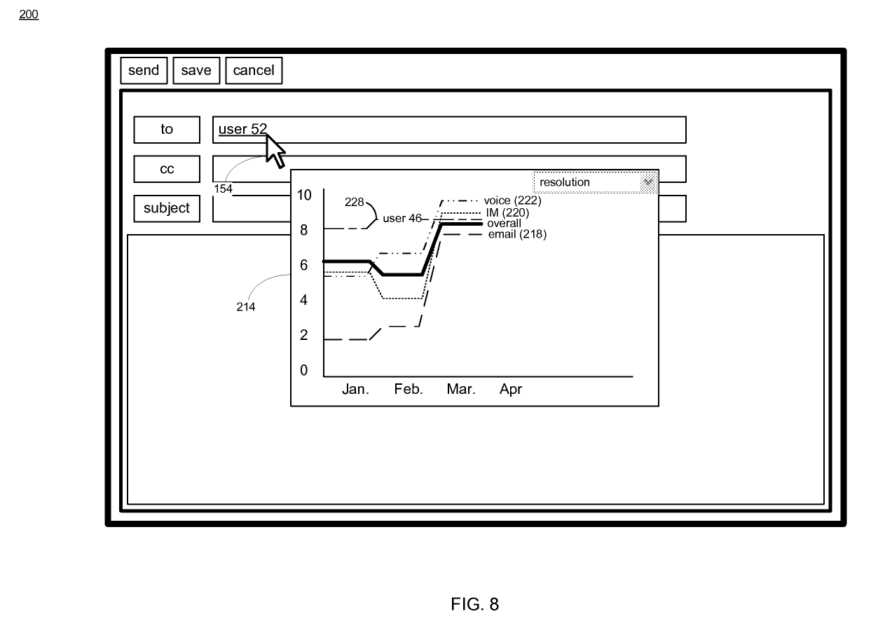

Additionally, providing 104 a user response profile may include providing the user response profile with respect to all interactions, or with respect to interactions with one or more specified users. For example, and referring also to FIG. 8, in addition/as an alternative to trends 216, 218, 220, 222, response history graph 214 may include trend 228 indicating user 52's responsiveness to communications from user 46. As shown, despite relatively poor responsiveness during the months of January and February, user 52 may have been consistently responsive to communications from user 46. Response history graph 214 may be adapted to show greater resolution in terms of user 52's responsiveness to various other users. For example, while not shown, response history graph 214 may include trends indicating user 52's responsiveness to a plurality of selected and/or predefined users.

Interaction tracking process 10 may provide 104 the user response profile based upon, at least in part, user response pattern data, e.g., which may be aggregated in a centralized system (e.g., response database 64 residing on server computer 12). Response database 64 may be responsive to web services requests for interaction data. Continuing with the above-stated example, when user 46, e.g., right-clicks on user 52's email address, interaction tracking process 10 and/or relationship client application 22 may issue a web services request to response database 64. Interaction tracking process 10 and/or relationship client application 22 may provide 104 the user response profile (e.g., in the form of response profile popup 202 or response history graph 214) based upon response pattern data provided from response database 64 in response to the web services request.

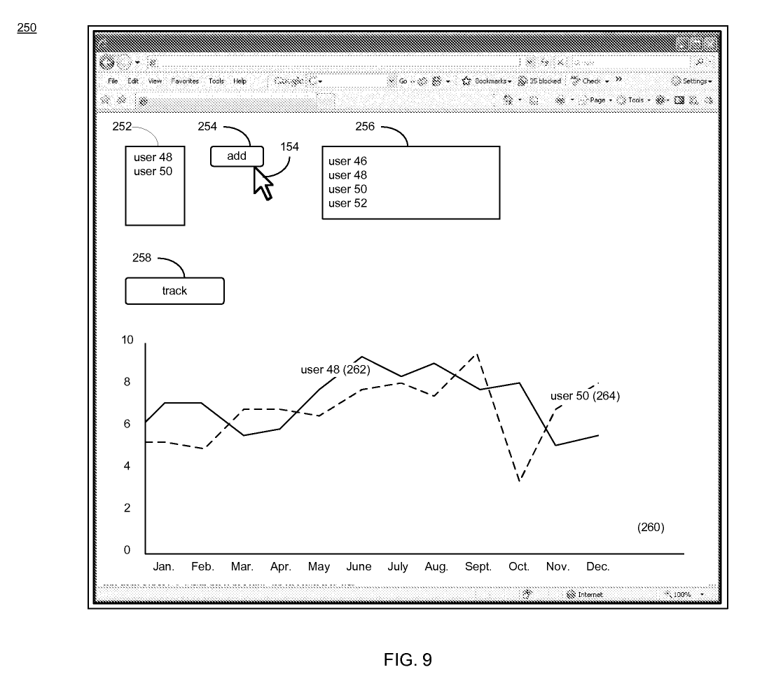

Providing 104 the response profile to a third party may include providing 104 the response profile to a user such as an administrator, manager, or the like. For example, and referring also to FIG. 9, interaction tracking process 10 may provide (e.g., in conjunction with an application such as a web browser) user interface screen 250. Via user interface screen 250, interaction tracking process 10 provide 104 a response profile or one or more other users. User interface screen 250 may include user list 252. A user, e.g., user 46, may add one or more users to user list 252, for example, by selecting, via onscreen pointer 154, “add” button 254. Selecting “add” button 254 may result in interaction tracking process 10 rendering user selection menu 256, including a listing of users (namely, user 46, user 48, user 50, user 52). Via user selection menu 256, user 46 may add one or more users to user list 252 (e.g., user 48 and user 50).

Once the desired users have been added to user list 252, user 46 may select “track responsiveness” button 258. Selecting “track” button 258 may result in interaction tracking process 10 rendering responsiveness chart 260. Responsiveness chart 260 may be based upon, at least in part, response pattern data (e.g., residing in response database 64), which may be received in response to a web services request for response pattern data for the selected user. Similar to previously discussed aspects, responsiveness chart 260 may include one or more trend lines (e.g., trend lines 262, 264) indicative of the responsiveness of each selected user (e.g., user 48 and user 50). In addition/as an alternative to responsiveness chart 260, data relating to user responsiveness may be presented in a text format and/or a combination of graphics and text.

A number of implementations have been described. Nevertheless, it will be understood that various modifications may be made. Accordingly, other implementations are within the scope of the following claims.

What is claimed is:

1. A method comprising:
monitoring a plurality of interactions of a user;
defining an response pattern of the user based upon, at least in part, the plurality of interactions of the user; and
providing a response profile of the user based upon, at least in part, the response pattern of the user.

2. The method of claim 1, wherein the plurality of interactions include interactions on one or more communication channel.

3. The method of claim 1, wherein the plurality of interactions include one or more of emails, instant messages, text messages, and voice communications, and scheduled meetings.

4. The method of claim 1, wherein the response pattern of the user is based upon, at least in part, one or more communications sent to the user.

5. The method of claim 1, wherein the response pattern of the user is based upon, at least in part, one or more communications originated by the user.

6. The method of claim 1, wherein providing the response profile of the user includes providing the interaction profile to the user.

7. The method of claim 1, wherein providing the response profile of the user includes providing the response profile to a third party.

8. The method of claim 1, wherein the response profile of the user includes a number of communications not responded to.

9. The method of claim 1, wherein the response profile of the user includes an average time for responding to communications.

10. The method of claim 1, wherein the response profile of the user includes information about a plurality of communication channels.

11. A computer program product residing on a computer readable medium having a plurality of instructions stored thereon which, when executed by a processor, cause the processor to perform operations comprising:
monitoring a plurality of interactions of a user;
defining a response pattern of the user based upon, at least in part, the plurality of interactions of the user; and
providing an response profile of the user based upon, at least in part, the response pattern of the user.

12. The computer program product of claim 11, wherein the plurality of interactions include interactions on one or more communication channel.

13. The computer program product of claim 11, wherein the plurality of interactions include one or more of emails, instant messages, text messages, and voice communications, and scheduled meetings.

14. The computer program product of claim 11, wherein the response pattern of the user is based upon, at least in part, one or more communications sent to the user.

15. The computer program product of claim 11, wherein the response pattern of the user is based upon, at least in part, one or more communications originated by the user.

16. The computer program product of claim 11, wherein the instructions for providing the response profile of the user include instructions for providing the response profile to the user.

17. The computer program product of claim 11, wherein the instructions for providing the response profile of the user include instructions for providing the response profile to a third party.

18. The computer program product of claim 11, wherein the response profile of the user includes a number of communications not responded to.

19. The computer program product of claim 11, wherein the response profile of the user includes an average time for responding to communications.

20. The computer program product of claim 11, wherein the response profile of the user includes information about a plurality of communication channels.
